(19) United States
(12) Patent Application Publication
(10) Pub. No.: US 2005/0229388 A1
(43) Pub. Date: Oct. 20, 2005

(54) Multi-layer ceramic chip varistor device surface insulation method

(76) Inventors: Sheng-Ming Deng, Hsinchu City (TW); Ching-Lung Tseng, Miao-Li Hsien (TW)

Correspondence Address: SUPREME PATENT SERVICES, POST OFFICE BOX 2339, SARATOGA, CA, 95070, US

(21) Appl. No.: 10/829,052

(22) Filed: Apr. 20, 2004

(51) Int. Cl. H01C 17/28

(52) U.S. Cl. 29/621; 29/620

(57) ABSTRACT

Disclosed is a method for insulating external surfaces of a multi-layer ceramic chip varistor device, wherein a high insulating material is coated on external surfaces of the device before the device's external electrodes are plated in an electroplating process. Then after a heat treatment process, the high insulating material reacts with the device's ceramic body surface material to form an insulating layer. A conventional electroplating process for chip devices can be applied to plate the device's external electrodes with a layer of soldering interface so that the external electrodes have a better solderability. The insulating layer protects the device's ceramic body from being plated and the external electrodes are not short-circuited to cause device failure. In addition, if coating the insulating layer is performed before the device's external electrodes are formed, the insulating layer may obstruct a good electric contact to be established between internal electrodes originally exposed out of the ceramic body and the subsequently formed external electrodes. A dip etching method and a heat treatment method are employed to extend the internal electrodes outward so that a good electric contact between the internal and external electrodes is ensured.

### FIELD OF THE INVENTION

The present invention relates to a multi-layer ceramic chip varistor device, and more particularly, to a method for insulating external surfaces of a multi-layer ceramic chip varistor device. A conventional electroplating process for chip devices can be applied to plate the device's external electrodes with a layer of soldering interface so that the external electrodes have a better solderability. The device's ceramic body is protected by the insulated surfaces from being plated and the external electrodes are not short-circuited to cause device failure.

### BACKGROUND OF THE INVENTION

In recent years, multi-layer ceramic chip varistors have been widely used on electric circuits of computer and communications products to protect electronic components from a surge voltage.

As shown in FIGS. 1A, 1B, and 1C, a multi-layer ceramic chip varistor device according to a prior art, through steps of green sheet preparation, screen-printing, stacking, laminating, cutting, and forming external electrodes, is formed into a device including a ceramic body 12, internal electrodes 22, and external electrodes 32. The ceramic body is usually made of a semiconducting or low insulating material, and the external electrodes are usually made of an Ag, Ag—Pd, or Ag—Pd—Pt alloy. In order to make the external electrodes more solderable to an electric circuit board, a layer of soldering interface is plated on the external electrodes after their formation through an electroplating process. However, as the ceramic body is made of a semiconducting material, metallic components such as Ni, Pb—Sn, or Sn from a plating solution would be plated on the ceramic body during the foregoing electroplating process as well. This would cause the external electrode to be short-circuited and the device becomes defective.

A conventional method for overcoming the foregoing problem is to use a material including precious metals to form the external electrodes so that an extra layer of soldering interface is not required to achieve a desired solderability. However external electrodes of precious metals still cannot reach a same level of soldering quality and standard as external electrodes plated with a soldering interface.

According to prior arts, three methods have been developed to allow the use of electroplating on the external electrodes while avoiding the ceramic body to be plated as well. The three methods and their disadvantages are described as follows.

In a method disclosed in EU Patent No. 0806780, a multi-layer ceramic electronic device is immersed in a phosphate solution before electroplating. A major constituent of the device's ceramic body, Zinc oxide, is dissolved and reacts with the solution to form a Zinc phosphate. The Zinc phosphate is then deposited on the ceramic body's surfaces to form an insulating coating, which will prevent the ceramic body from being plated during a subsequent electroplating process. The method requires a careful control of the solution's concentration, temperature, and pH value. Wasted solution processing also increases production costs and causes environmental problems.

In a method disclosed in Taiwan Patent No. 447775, a multi-layer ceramic electronic device's ceramic body is covered with an insulating layer before forming external electrodes. However the insulating layer may obstruct a good electric contact to be established between internal electrodes originally exposed out of the ceramic body and the subsequently formed external electrodes, thereby reducing the device's effectiveness and reliability. Therefore an additional process is required for weeding out the insulating layer at regions where the external electrodes are to be formed. In addition, a choice of materials for the insulating layer also affects what materials to use for external electrodes, as a sintering temperature for the external electrodes has to be lower than what the insulating layer can sustain.

In a method disclosed in U.S. Pat. No. 6,232,867, a multi-layer ceramic electronic device's ceramic body is covered with a first layer of external electrodes, and then covered with a first layer of glass insulation, and again covered with a second layer of glass insulation of different constituents, and then covered a second layer of external electrodes, and at last the external electrodes' plating is conducted. The method involves four heat treatment processes and therefore a production cost control is difficult due to complexities in material choices and processes.

Accordingly, the present invention is directed to obviate limitations and disadvantages of the related arts.

### SUMMARY OF THE INVENTION

The present invention is directed to a problem in fabricating a multi-layer ceramic chip varistor device. The problem lies in that a layer of soldering interface is plated on the device's external electrodes after their formation through an electroplating process so that the external electrodes have a satisfactory solderability. However, as the device's ceramic body is made of a semiconducting material, metallic components such as Ni, Pb—Sn, or Sn from a plating solution would be plated on the ceramic body during the foregoing electroplating process as well. This would cause the external electrode to be short-circuited and thereby the device becomes defective.

To overcome the foregoing problem, the present invention coats a layer of glass, organic compound, metallic oxide, metallic salt, or other high insulating material on external surfaces of a multi-layer ceramic chip varistor device's ceramic body. After a heat treatment process, an insulating layer is formed on the ceramic body's surfaces. A conventional electroplating process can then be applied to plate the device's external electrodes with a layer of soldering interface so that the external electrodes have a better solderability. The insulating layer protects the ceramic body from being plated during the electroplating process. The external electrodes are therefore not short-circuited to cause device failure. Coating an insulating layer on the ceramic body's surfaces can be performed before the ceramic body is sintered, after the ceramic body is sintered but before the external electrodes are formed, or after the ceramic body is sintered and the external electrodes are formed.

In addition, if coating an insulating layer is performed before the external electrodes are formed, the insulating layer may obstruct a good electric contact to be established between internal electrodes originally exposed out of the ceramic body and the subsequently formed external electrodes. The present invention utilizes a dip etching method and a heat treatment method to extend the internal electrodes outward so that a good electric contact between the internal and external electrodes is ensured.

Compared with prior arts, the present invention has the following advantages:

(1) The insulating layer does not restrict a choice of materials for the external electrodes.

(2) The insulating layer flattens the ceramic body's surfaces and therefore facilitates the cleaning of flux after a subsequent soldering process. A possibility of device defect due to flux residues and electric leakage is therefore reduced.

(3) The present invention's way of extending the internal electrodes can ensure a good electric contact established between the internal and external electrodes without an additional process for weeding out the insulating layer at regions where the external electrodes are to be formed.

(4) A heat treatment process for the insulating layer can be conducted simultaneously with a sintering process of the external electrodes, or with a sintering process of the ceramic body.

### BRIEF DESCRIPTION OF THE DRAWINGS

FIG. 1A is a schematic, plan diagram of a multi-layer ceramic chip varistor device according to a prior art.

FIG. 1B is a schematic, cross-sectional diagram in a vertical direction of a multi-layer ceramic chip varistor device according to a prior art as shown in FIG. 1A.

FIG. 1C is a schematic, cross-sectional diagram in a horizontal direction of a multi-layer ceramic chip varistor device according to a prior art as shown in FIG. 1A.

FIG. 2A is a schematic, cross-sectional diagram of a multi-layer ceramic chip varistor device according to a first embodiment of the present invention showing a glass coating layer on a ceramic green compact before the green compact's sintering.

FIG. 2B is a schematic, cross-sectional diagram showing an insulating layer formed on external surfaces of a ceramic body of the device as illustrated in FIG. 2A after the device is put through a sintering process.

FIG. 2C is a schematic, cross-sectional diagram showing external electrodes coated and sintered with the device as illustrated in FIG. 2B.

FIG. 2D is a schematic, cross-sectional diagram showing the device as illustrated in FIG. 2C after the device is put through a heat treatment process.

FIG. 3A is a schematic, cross-sectional diagram of a multi-layer ceramic chip varistor device according to a second embodiment of the present invention showing the device after its ceramic body is sintered but before external electrodes are formed.

FIG. 3B is a schematic, cross-sectional diagram showing an insulating layer formed on external surfaces of the ceramic body of the device as illustrated in FIG. 3A after the device is coated with a mixed oxide coating layer and put through a heat treatment process.

FIG. 3C is a schematic, cross-sectional diagram showing external electrodes coated and sintered with the device as illustrated in FIG. 3B.

FIG. 3D is a schematic, cross-sectional diagram showing the device as illustrated in FIG. 3C after the device is put through a heat treatment process.

FIG. 4A is a schematic, cross-sectional diagram of a multi-layer ceramic chip varistor device according to a third embodiment of the present invention showing the device after its ceramic body is sintered but before external electrodes are formed.

FIG. 4B is a schematic, cross-sectional diagram showing the device as illustrated in FIG. 4A after the device is immersed in a 0.5% HCl solution for one minute and the device's internal electrodes are exposed.

FIG. 4C is a schematic, cross-sectional diagram showing an insulating layer formed on external surfaces of the ceramic body of the device as illustrated in FIG. 4B after the device is coated with a glass coating layer and put through a heat treatment process.

FIG. 4D is a schematic, cross-sectional diagram showing external electrodes coated and sintered with the device as illustrated in FIG. 4C.

FIG. 5A is a schematic, cross-sectional diagram of a multi-layer ceramic chip varistor device according to a fourth embodiment of the present invention showing the device after the its ceramic body is sintered and external electrodes are formed.

FIG. 5B is a schematic, cross-sectional diagram showing a glass coating layer coated on external surfaces of the device as illustrated in FIG. 5A.

FIG. 5C is a schematic, cross-sectional diagram showing an insulating layer formed on external surfaces of the ceramic body of the device as illustrated in FIG. 5B after the device is put through a heat treatment process.

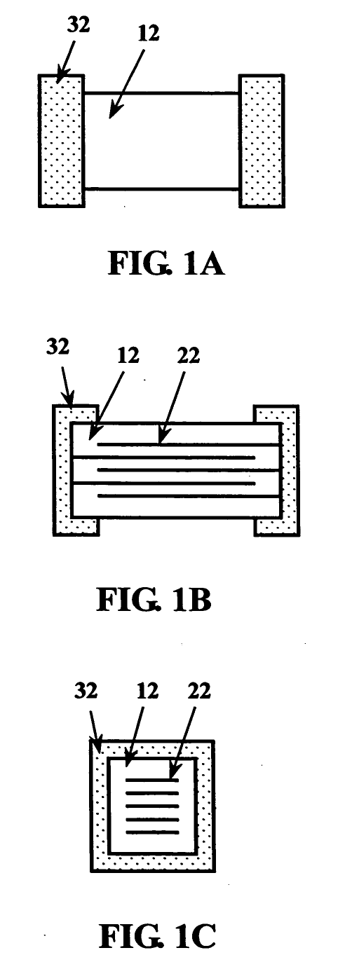

### DETAILED DESCRIPTION OF THE INVENTION

The present invention coats a layer of glass, organic compound, metallic oxide, metallic salt, or other high insulating material on external surfaces of a multi-layer ceramic chip varistor device's ceramic body. After a heat treatment process, an insulating layer is formed on the ceramic body's surfaces. A conventional electroplating process can then be applied to plate the device's external electrodes with a layer of soldering interface so that the external electrodes have a better solderability. The insulating layer protects the ceramic body from being plated during the electroplating process. The external electrodes are therefore not short-circuited to cause device failure. Coating an insulating layer on the ceramic body's surfaces can be performed before the ceramic body is sintered, after the ceramic body is sintered but before the external electrodes are formed, or after the ceramic body is sintered and the external electrodes are formed. These processes are described as follows.

If coating an insulating layer on the ceramic body's surfaces is performed before the ceramic body is sintered, a layer of glass, organic compound, metallic oxide, metallic salt, or other high insulating material is first coated with thickness 1-100 μm on external surfaces of a multi-layer ceramic green compact. Then, after a sintering process, an insulating layer is formed on the external surfaces of the sintered, semiconducting ceramic body.

If coating an insulating layer on the ceramic body's surfaces is performed after the ceramic body is sintered but before the external electrodes are formed, a layer of glass, organic compound, metallic oxide, metallic salt, or other high insulating material is coated with thickness 1-200 μm on the sintered ceramic body without external electrodes. Then, after a heat treatment process, an insulating layer is formed from a reaction between the coated insulating material and the ceramic body's semiconducting ceramic material.

If coating an insulating layer on the ceramic body's surfaces is performed after the ceramic body is sintered and the external electrodes are formed, a layer of glass, organic compound, metallic oxide, metallic salt, or other high insulating material is coated with thickness 1-50 μm on the device's entire surfaces after the device's sintering and external electrode forming processes. Then, after a heat treatment process, an insulating layer is formed from a reaction between the coated insulating material and the ceramic body's semiconducting ceramic material. The coated insulating material on the external electrodes is dissolved or blended into the external electrode and therefore does not affect a subsequent electroplating process and an electric current conduction.

If the foregoing coating of an insulating layer is performed before the external electrodes are formed, the insulating layer may obstruct a good electric contact to be established between internal electrodes originally exposed out of the ceramic body and the subsequently formed external electrodes. Therefore the internal electrodes have to be extended outward to ensure a good electric contact can be established between the internal and external electrodes. The present invention can extend the internal electrodes in the following two ways.

In one way, the sintered ceramic body is immersed in an acid or alkaline solution before forming the external electrodes. By controlling a pH value and an immersed time of the acid or alkaline solution, the internal electrodes are exposed out of the ceramic body as the ceramic body is etched and shrunk while the metallic internal electrodes can better withstand the acid or alkaline solution.

In another way, the ceramic body coated with the insulating layer is put through a heat treatment process above 250° C. before forming the external electrodes. Then, as Silver (Ag) is contained in both the internal and external electrodes, in the subsequent formation of the external electrodes, the Silver contained in the internal electrodes is attracted by the Silver contained in the external electrodes and the internal electrodes thereby extend outward.

To give further understanding of the present invention, preferred embodiments of the present invention are described in details as follows.

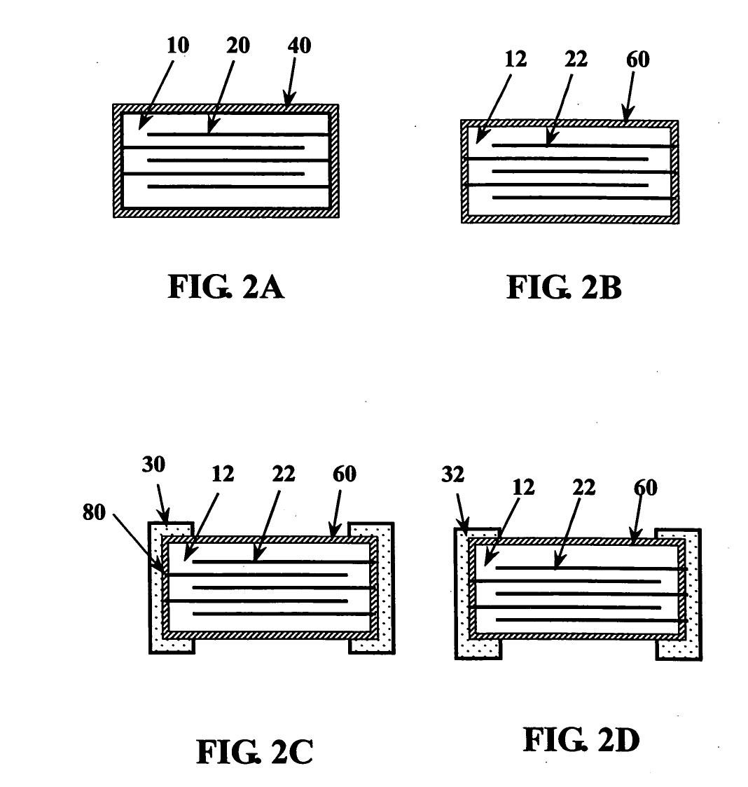

In a first embodiment of the present invention, an insulating layer is coated on a ceramic body before the ceramic body is sintered. A ceramic material is put though processes including green sheet preparation, screen-printing, stacking, and cutting into monolithic green compacts. As shown in FIG. 2A, each individual green compact contains a ceramic body 10 and internal electrodes 20. Then a glass coating layer 40 whose major constituents are Boron-Silicon is coated on external surfaces of the ceramic body. After the coating layer is dried, it has a thickness about 20-30 μm. Then the green compact and the coating layer are sintered together under a same sintering process condition used for conventional green compacts without coating layers. After sintering, a device as shown in FIG. 2B is formed which includes a sintered ceramic body 12, internal electrodes 22, and an insulating layer 60 resulted from a reaction between the glass coating layer and a surface material of the ceramic body.

Then external electrodes 30 are coated and sintered with the device as shown in FIG. 2C in a sintering process. A small amount of glass coating 80 may remain on an end of the originally exposed internal electrode 22 and thereby obstruct an electric contact between the internal and external electrodes 22 and 30. Therefore a heat treatment process above 500° C. is subsequently performed. As shown in FIG. 2D, as Silver contained in the internal electrodes 22 is attracted by Silver contained in the external electrode 32. The internal electrodes 22 thereby extends outward and a good electric contact is established. With an appropriate choice of materials of the external electrodes, the heat treatment process causing the internal electrodes to extend and the sintering process of external electrodes can be combined and performed simultaneously to achieve a same result.

After the foregoing processes, the device can be plated with a conventional electroplating process used on chip devices to achieve a better solderability for the external electrodes. The ceramic body between the external electrodes is not plated due to the insulating layer.

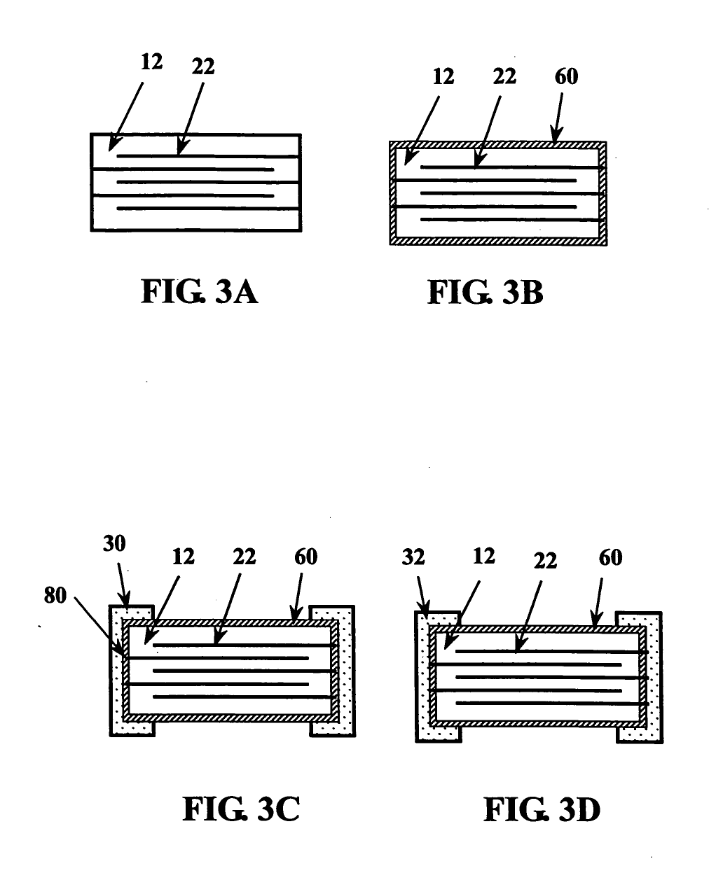

In a second embodiment of the present invention, an insulating layer is coated on a ceramic body after the ceramic body is sintered but before forming external electrodes. A ceramic material is put though processes including green sheet preparation, screen-printing, stacking, cutting, and sintering. As shown in FIG. 3A, a device is formed which includes a ceramic body 12 and internal electrodes 22. Then a mixed oxide coating layer 40 whose major constituents are Zinc-Boron-Silicon is coated on external surfaces of the sintered device. Then the device is put through a heat treatment process between 500° C.-850° C. Then a device as shown in FIG. 3B is formed which includes a ceramic body 12, internal electrodes 22, and an insulating layer 60 resulted from a reaction between the mixed oxide coating layer and a surface material of the ceramic body during the heat treatment process.

Then external electrodes 30 are coated and sintered with the device as shown in FIG. 3C in a sintering process. A small amount of mixed oxide coating 80 may remain on an end of the originally exposed internal electrode 22 and thereby obstruct an electric contact between the internal and external electrodes 22 and 30. Therefore a heat treatment process above 500° C. is subsequently performed. As shown in FIG. 3D, a Silver contained in the internal electrodes 22 is attracted by Silver contained in the external electrode 32. The internal electrodes 22 thereby extends outward and a good electric contact is established. With an appropriate choice of materials of the external electrodes, the heat treatment process causing the internal electrodes to extend, the heat treatment process forming the insulating layer, and the sintering process of external electrodes can be combined and performed simultaneously to achieve a same result.

After the foregoing processes, the device can be plated with a conventional electroplating process used on chip devices to achieve a better solderability for the external electrodes. The ceramic body between the external electrodes is not plated due to the insulating layer.

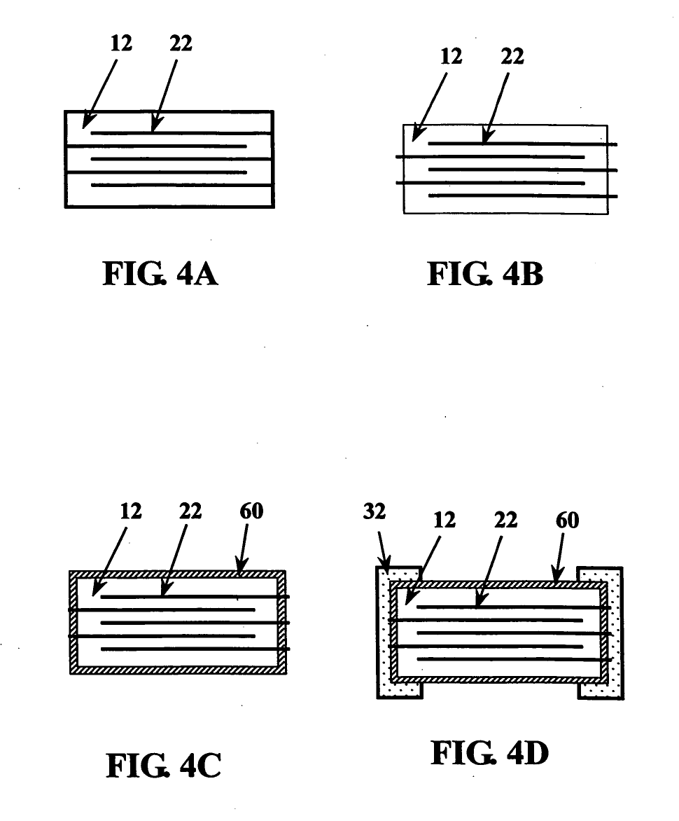

In a third embodiment of the present invention, an insulating layer is coated on a ceramic body after the ceramic body is sintered but before forming external electrodes. A ceramic material is put though processes including green sheet preparation, screen-printing, stacking, cutting, and sintering. As shown in FIG. 4A, a device is formed which includes a ceramic body 12 and internal electrodes 22. Then the device is immersed in a 0.5% HCl solution for one minute. As the ceramic body 12 is etched and shrunk, the internal electrodes 22's ends are thereby exposed as shown in FIG. 4B. Then a glass coating layer whose major constituents are Zinc-Boron-Silicon is coated on external surfaces of the device. Then the device is put through a heat treatment process between 500° C.-700° C. Then a device as shown in FIG. 4C is formed which includes a ceramic body 12, internal electrodes 22, and an insulating layer 60 resulted from a reaction between the glass coating layer and a surface material of the ceramic body during the heat treatment process.

Then external electrodes 32 are coated and sintered with the device as shown in FIG. 4D in a sintering process. A good electric contact is established between the exposed internal electrode 22 and the external electrodes 32. The heat treatment process forming the insulating layer and the sintering process of external electrodes can be combined and performed simultaneously to achieve a same result.

After the foregoing processes, the device can be plated with a conventional electroplating process used on chip devices to achieve a better solderability for the external electrodes. The ceramic body between the external electrodes is not plated due to the insulating layer.

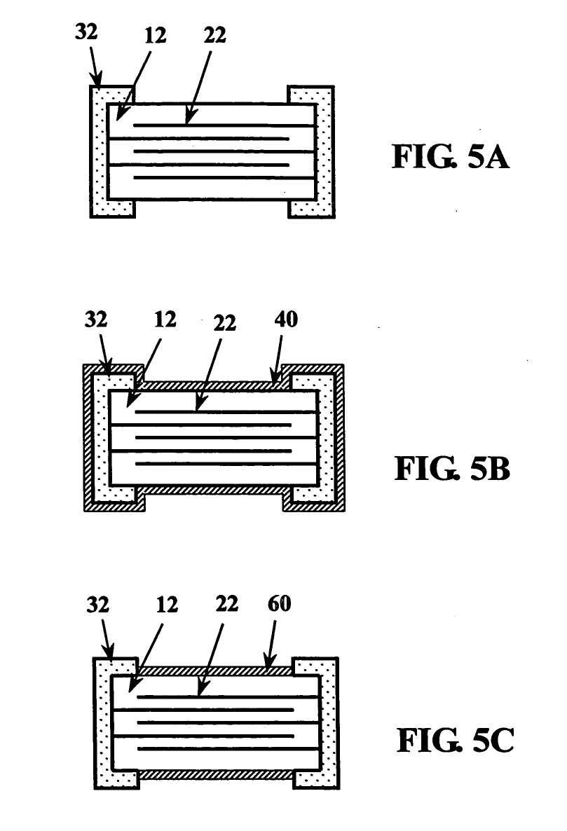

In a fourth embodiment of the present invention, as shown in FIG. 5A, a multi-layer ceramic chip varistor device is formed through a conventional fabrication process which includes a ceramic body 12, internal electrodes 22, and external electrodes 32. Then a glass coating layer 40 whose major constituents are Lead-Zinc-Boron-Silicon is coated on external surfaces of the device as shown in FIG. 5B. Then the device is put through a heat treatment process between 500° C.-700° C. Then a device as shown in FIG. 5C is formed which includes a ceramic body 12, internal electrodes 22, external electrodes 32, and an insulating layer 60 resulted from a reaction between the glass coating layer and a surface material of the ceramic body during the heat treatment process. The insulating coating on the external electrodes is dissolved or blended into the external electrode during the heat treatment process. The external electrodes still maintain a good electrical conducting property. The heat treatment process forming the insulating layer and the sintering process of external electrodes can be combined and performed simultaneously to achieve a same result.

After the foregoing processes, the device can be plated with a conventional electroplating process used on chip devices to achieve a better solderability for the external electrodes. The ceramic body between the external electrodes is not plated due to the insulating layer.

The foregoing preferred embodiments of the present invention are exemplary and explanatory, and are not intended to provide any restriction to the presentation invention. To those skilled in the related arts, various modifications and variations can be made to embodiments of the present invention without departing from the spirit and scope of the present invention as claimed.

1. A method for insulating external surfaces of a multi-layer ceramic chip varistor device, comprising:
coating a high insulating material on external surfaces of a multi-layer ceramic green compact;
sintering the green compact into a ceramic body and forming an insulating layer on the ceramic body's surfaces;
coating and sintering external electrodes onto the ceramic body in a sintering process; and
extending internal electrodes inside the ceramic body by a heat treatment process to ensure a good electric contract between the internal and external electrodes.

2. The method according to claim 1, wherein the heat treatment process causing the internal electrodes to extend and the sintering process of external electrodes can be combined and performed simultaneously to achieve a same result as the two processes are performed separately.

3. A method for insulating external surfaces of a multi-layer ceramic chip varistor device, comprising:
coating a high insulating material on external surfaces of a ceramic body after the ceramic body is sintered but before the device's external electrodes are formed;
forming an insulating layer on external surfaces of the ceramic body after the ceramic body is put through a heat treatment process;
coating and sintering external electrodes onto the ceramic body in a sintering process; and
extending internal electrodes inside the ceramic body by a heat treatment process to ensure a good electric contract between the internal and external electrodes.

4. The method according to claim 3, wherein the heat treatment process causing the internal electrodes to extend, the heat treatment process forming the insulating layer, and the sintering process of external electrodes can be combined and performed simultaneously to achieve a same result as the three processes are performed separately.

5. A method for insulating external surfaces of a multi-layer ceramic chip varistor device, comprising:
immersing the device's ceramic body in an acid or alkaline solution in a dip etching process after the ceramic body is formed but before the device's external electrodes are formed, during which the device's internal electrodes are exposed out of the ceramic body as the ceramic body is etched and shrunk;
coating a high insulating material on external surfaces of the ceramic body;
forming an insulating layer on external surfaces of the ceramic body after the ceramic body is put through a heat treatment process; and
coating and sintering external electrodes onto the ceramic body in a sintering process during which a good electric contact is established and ensured between the internal and external electrodes.

6. The method according to claim 5, wherein the heat treatment process forming the insulating layer and the sintering process of external electrodes can be combined and performed simultaneously to achieve a same result as the two processes are performed separately.

7. A method for insulating external surfaces of a multi-layer ceramic chip varistor device, comprising:
coating a high insulating material on external surfaces of the device after the device's ceramic body is formed, and after the device's external electrodes are formed in a sintering process, but before the external electrodes are plated with an electroplating process; and
forming an insulating layer on external surfaces of the device after the device is put through a heat treatment process during which the insulating material on the external electrodes' surfaces is dissolved and blended with the external electrodes and the external electrodes still maintain a good conducting property.

8. The method according to claim 7, wherein the heat treatment process forming the insulating layer and the sintering process of external electrodes can be combined and performed simultaneously to achieve a same result as the two processes are performed separately.

9. The method according to claim 1, wherein the high insulating material is glass.

10. The method according to claim 3, wherein the high insulating material is glass.

11. The method according to claim 5, wherein the high insulating material is glass.

12. The method according to claim 7, wherein the high insulating material is glass.

13. The method according to claim 1, wherein the high insulating material is an organic compound.

14. The method according to claim 3, wherein the high insulating material is an organic compound.

15. The method according to claim 5, wherein the high insulating material is an organic compound.

16. The method according to claim 7, wherein the high insulating material is an organic compound.

17. The method according to claim 1, wherein the high insulating material is metallic oxide.

18. The method according to claim 3, wherein the high insulating material is metallic oxide.

19. The method according to claim 5, wherein the high insulating material is metallic oxide.

20. The method according to claim 7, wherein the high insulating material is metallic oxide.

21. The method according to claim 1, wherein the high insulating material is a metallic salt.

22. The method according to claim 3, wherein the high insulating material is a metallic salt.

23. The method according to claim 5, wherein the high insulating material is a metallic salt.

24. The method according to claim 7, wherein the high insulating material is a metallic salt.

25. The method according to claim 1, wherein the method is applied to insulate external surfaces of chip devices using a semiconducting or low insulating material as the devices' bodies.

26. The method according to claim 3, wherein the method is applied to insulate external surfaces of chip devices using a semiconducting or low insulating material as the devices' bodies.

27. The method according to claim 5, wherein the method is applied to insulate external surfaces of chip devices using a semiconducting or low insulating material as the devices' bodies.

28. The method according to claim 7, wherein the method is applied to insulate external surfaces of chip devices using a semiconducting or low insulating material as the devices' bodies

29. The method according to claim 1, wherein the heat treatment process causing the internal electrodes to extend has a characteristics that, after an insulating layer and external electrodes are formed on the device, the heat treatment process is conducted above 250° C. causing Silver contained in the internal electrodes to be attracted out of the ceramic body by Silver contained in the external electrodes.

30. The method according to claim 3, wherein the heat treatment process causing the internal electrodes to extend has a characteristics that, after an insulating layer and external electrodes are formed on the device, the heat treatment process is conducted above 250° C. causing Silver contained in the internal electrodes to be attracted out of the ceramic body by Silver contained in the external electrodes.

31. The method according to claim 5, wherein the dip etching process exposing the internal electrodes has a characteristics that, after the ceramic body is sintered but before an insulating layer is formed, the device is immersed in an acid or alkaline solution so that the ceramic body is etched and shrunk causing the internal electrodes to expose out of the ceramic body.

32. The method according to claim 1, wherein the heat treatment process causing the internal electrodes to extend cal also be applied to chip devices using a semiconducting or low insulating material as the devices' bodies.

33. The method according to claim 14, wherein the heat treatment process causing the internal electrodes to extend cal also be applied to chip devices using a semiconducting or low insulating material as the devices' bodies.

34. The method according to claim 3, wherein the heat treatment process causing the internal electrodes to extend cal also be applied to chip devices using a semiconducting or low insulating material as the devices' bodies

35. The method according to claim 15, wherein the heat treatment process causing the internal electrodes to extend cal also be applied to chip devices using a semiconducting or low insulating material as the devices' bodies.

36. The method according to claim 4, wherein the dip etching process exposing the internal electrodes cal also be applied to chip devices using a semiconducting or low insulating material as the devices' bodies.

37. The method according to claim 16, wherein the dip etching process exposing the internal electrodes cal also be applied to chip devices using a semiconducting or low insulating material as the devices' bodies.
